(19) United States
(12) Patent Application Publication
(10) Pub. No.: US 2020/0126253 A1
(43) Pub. Date: Apr. 23, 2020

(54) METHOD OF BUILDING OBJECT-RECOGNIZING MODEL AUTOMATICALLY

(71) Applicant: NEXCOM Intelligent Systems CO., LTD., New Taipei City (TW)

(72) Inventor: Hui-Yi CHIEN, New Taipei City (TW)

(21) Appl. No.: 16/411,093

(22) Filed: May 13, 2019

(30) Foreign Application Priority Data
Oct. 17, 2018 (TW) 107136558

(51) Int. Cl. G06T 7/73

(52) U.S. Cl. CPC G06T 7/74; G06T 2207/20081

(57) ABSTRACT

A method of building object-recognizing model automatically retrieves sample images corresponding to different angles of views of an appearance of a physical object by an image capturing device, configures identification information of the sample images, selects one of cloud training service providers according to user's operation, transmits the sample images and the identification information to a cloud server of the selected cloud training service provider for making the cloud server execute a learning training on the sample images, and receives an object-recognizing model corresponding to the identification information from the cloud server. Thereby, the development time is dramatically shortened and the development efficiency is significantly improved.

### BACKGROUND OF THE INVENTION

### Field of the Invention

The technical field relates to an object recognition method, and more particularly related to a method of building object-recognizing model automatically.

### Description of Related Art

In the related art, when a user would like to use a computer to execute an object recognition on a specific physical object, the developer must self-induct the rules to recognize the specific physical object via repeating observation of the specific physical objects. Above status wastes mass development time and drastically reduces development efficiency.

Accordingly, there is currently a need for a schema having the ability to building object-recognizing model automatically.

### SUMMARY OF THE INVENTION

The disclosure is directed to a method of building object-recognizing model automatically, having the ability to lead the user selecting the suitable cloud training service provider for generating the object-recognizing model automatically.

One of the exemplary embodiments, a method of building object-recognizing model automatically, comprises following steps: capturing a plurality of different angles of views of appearance of a first physical object by an image capture device in a training mode for obtaining a plurality of sample images; configuring identification information of the sample images, wherein the identification information is used to represent the first physical object; selecting one of a plurality of cloud training service providers according to a provider-selecting operation; transmitting the sample images and the identification information to a cloud server of the selected cloud training service provider for making the cloud server execute a learning training on the sample images; and receiving an object-recognizing model corresponding to the identification information from the cloud server.

The present disclosed example can dramatically shorten the development time via automatically establishing the object-recognizing model for the physical object based on machine learning. Moreover, the present disclosed example can lead the developer selecting the suitable cloud training service providers and significantly improve development efficiency.

### BRIEF DESCRIPTION OF DRAWING

The features of the present disclosed example believed to be novel are set forth with particularity in the appended claims. The present disclosed example itself, however, may be best understood by reference to the following detailed description of the present disclosed example, which describes an exemplary embodiment of the present disclosed example, taken in conjunction with the accompanying drawings, in which:

FIG. 1 is an architecture diagram of an object-recognizing system according to an embodiment of the present disclosed example;

FIG. 2 is a schematic view of capturing a physical object according to one of embodiments of the present disclosed example;

FIG. 3 is a schematic view of recognizing a physical object according to one of embodiments of the present disclosed example;

FIG. 4 is a flowchart of a method of building object-recognizing model automatically according to the first embodiment of the present disclosed example;

FIG. 5 is a flowchart of recognizing physical object according to the second embodiment of the present disclosed example;

FIG. 6 is a flowchart of capturing physical object according to the third embodiment of the present disclosed example; and

FIG. 7 is a flowchart of a method of building object-recognizing model automatically according to the fourth embodiment of the present disclosed example.

### DETAILED DESCRIPTION OF THE INVENTION

In cooperation with attached drawings, the technical contents and detailed description of the present disclosed example are described thereinafter according to a preferable embodiment, being not used to limit its executing scope. Any equivalent variation and modification made according to appended claims is all covered by the claims claimed by the present disclosed example.

The present disclosed example mainly provides a technology of building object-recognizing model automatically having the ability to lead the user selecting the suitable cloud training service provider and using the machine learning service provided by the selected cloud training service provider for training according to the images of a designated physical object for building an object-recognizing model used to recognize the designated physical object. Then, the user may use this object-recognizing model to execute the object recognition on any physical object in life for determining whether the current physical object is the designated physical object.

More specifically, the above-mentioned object-recognizing model is the data model and records a plurality of recognition rules used to recognize the corresponding physical object. The computer apparatus (such as the local host described later) may determine whether any of the given images (such as the detection images described later) comprises an image of the corresponding physical object according to the plurality of recognition rules.

Furthermore, the object-recognizing model generated by the present disclosed example may be suitable for the unmanned stores, the unmanned rental shops, the unmanned warehousing, and the other unmanned application.

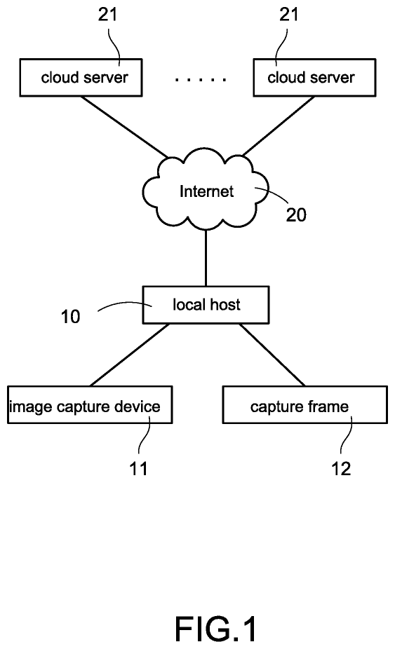

Please refer to FIG. 1, which is an architecture diagram of an object-recognizing system according to an embodiment of the present disclosed example. The system of building object-recognizing model of the present disclosed example mainly comprises one or more image capture device(s) (take one image capture device 11 for example in FIG. 1), a capture frame 12 and a local host 10 connected to the above devices.

The image capture device 11 is used to capture the physical object placed on the capture frame 12 for retrieving the sample images. One of the exemplary embodiments, the image capture device 11 may comprise one or more color tracing camera (such as RGB camera). The above-mentioned color tracing camera is used to retrieve the color sample images of the capture frame 12 (comprising the physical object placed on the capture frame 12).

The capture frame 12 is used to place the physical object for making the image capture device 11 capture the stable physical object. One of the exemplary embodiments, the capture frame 12 may comprise a rotation device (such as a rotary table or a track device). The rotation device may automatically or manually rotate the capture frame 12 to make the image capture device 11 have the ability to capture the different angles of views of the physical object placed on the capture frame 12 automatically or manually by the user, but this specific example is not intended to limit the scope of the present disclosed example.

One of the exemplary embodiments, the capture frame 12 is fixedly installed, and the image capture device 11 is arranged on the rotation device. The rotation device may make the image capture device 11 move around the capture frame 12 automatically or manually by the user, and make the image capture device 11 have the ability to capture the different angles of views of the physical object placed on the capture frame 12.

The local host 10 is connected to Internet, and has the ability to connect to any of the cloud servers 21 of the different cloud training service providers. Under a training mode, the local host 10 may transmit the sample images to the designated cloud training service provider according to the user's operation for obtaining the corresponding object-recognizing model by cloud machine learning.

One of the exemplary embodiments, the local host 10 comprises non-transitory computer-readable media storing a computer program, and the computer program records a plurality of computer-readable codes. A processor of the local host 10 may execute the above-mentioned computer program to implement the method of building object-recognizing model automatically of each embodiment of the present disclosed example.

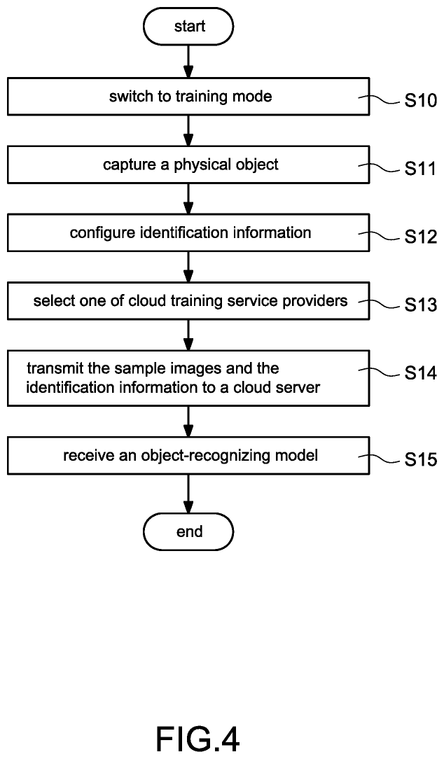

Please refer to FIG. 4, which is a flowchart of a method of building object-recognizing model automatically according to the first embodiment of the present disclosed example. The method of building object-recognizing model automatically of each embodiment of the present disclosed example may be implemented by the system shown in FIG. 1. The method of building object-recognizing model automatically of this embodiment comprises following steps.

Step S10: the local host 10 switches to the training mode when a trigger condition of training satisfies. One of the exemplary embodiments, the above-mentioned trigger condition of training may comprise reception of a pre-defined user operation (such as a button of enabling the training mode is pressed) or sensing a pre-defined status (such as sensing that the physical object is placed on the capture frame 12), but this specific example is not intended to limit the scope of the present disclosed example.

Step S11: the local host 10 control the image capture device 11 (namely the first image capture device) to capture the different angles of views of appearance of the physical model (namely the first physical object) placed on the capture frame 12 for obtaining a plurality of sample images respectively corresponding to the different angles of views of the physical object.

One of the exemplary embodiments, the local host 10 may control the image capture device 11 to move around the physical object by the rotation device, and control the image capture device 11 to capture at least one sample image of the physical object at the current angle of view each time circling the physical object for a designated angle.

One of the exemplary embodiments, the local host 10 may make the capture frame 12 be rotated by controlling the rotation device, and control the image capture device 11 to capture at least one sample image of the physical object at the current angle of view each time circling the physical object for a designated angle.

Step S12: the local host 10 configures the identification information on the generated sample images. More specifically, the local host 10 may comprise a human-machine interface (such as touch screen, keyboard, keypad, display, the other input/output devices, or any combination of the above device), and the user may input by the human-machine interface the identification information (such as product name, color, specification, type number, identification code, and so on) used to express the currently captured physical object.

Step S13: the local host 10 receives by the human-machine interface a provider-selecting operation inputted by the user, and selects one of a plurality of cloud training service providers according to the provider-selecting operation.

One of the exemplary embodiments, the local host 10 may display the electable option items on the human-machine interface (such as the display) for making the user select according to the user's requirement (such as selecting any of the cloud training service provider which the user had registered, the cloud training service provider having better service quality, the cloud training service provider with lower cost, and so on).

One of the exemplary embodiments, after the user selecting the cloud training service provider, the local host 10 may further receive by the human-machine interface the registration data (such as user account and password) of the selected cloud training service provider inputted by the user.

One of the exemplary embodiments, the cloud training service providers may comprise Microsoft Azure Custom Vision Service and/or Google Cloud AutoML Vision.

Step S14: the local host 10 transmits a plurality of sample images and the identification information to the cloud server 21 of the selected cloud training service provider for training. Then, the cloud server 21 executes the learning training on the received sample images for generating one group of object-recognizing models.

The above-mentioned “cloud server 21 executing learning training to generate the object-recognizing model” belongs to common technology in the cloud computing technology, therefore, the relevant description is omitted for brevity.

One of the exemplary embodiments, the local host 10 may further transmit the registration data to the cloud server 21, the cloud server 21 may authenticate the registration data, and then execute the learning training when determining that the registration data has the learning training authority (such as the available remain number is greater than zero).

Step S15: the cloud server 21 may notify the local host 10 when completing the learning training, and the local host 10 may receive (download) the object-recognizing model corresponding to the uploaded identification information from the cloud server 21. The above-mentioned object-recognizing model is used to recognize the physical object capture in the step S11. Thus, the user may get one group of the object-recognizing model for the physical object.

One of the exemplary embodiments, the user may replace the physical object on the capture frame 12 with another physical object, and operate the locate host 10 to perform the steps S10-S15 for getting another object-recognizing model for another physical object, and so forth.

Thus, the user may obtain a plurality of object-recognizing models for a plurality of physical objects by the present disclosed example, and achieve the recognition of multiple types of physical objects.

The present disclosed example can dramatically shorten the development time via automatically establishing the object-recognizing model for the physical object based on machine learning. Moreover, the present disclosed example can lead the developer selecting the suitable cloud training service providers and significantly improve development efficiency.

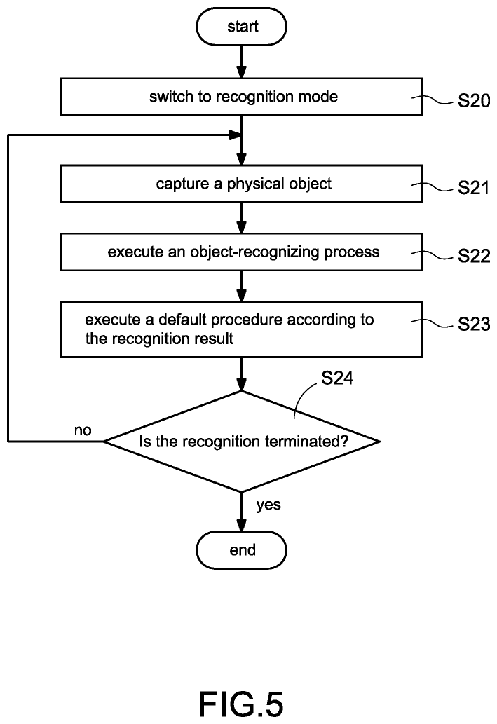

Please refer to FIG. 5, which is a flowchart of recognizing physical object according to the second embodiment of the present disclosed example. The method of building object-recognizing model automatically of this embodiment further comprises following steps for implementing a function of object recognition.

Step S20: local host 10 switches to the recognition mode when determining that a recognition trigger condition satisfies. One of the exemplary embodiments, the above-mentioned recognition trigger condition may comprise reception of a designated user operation (such as a button of enabling recognition mode is pressed).

One of the exemplary embodiments, the local host 10 may automatically load one or more stored object-recognizing model(s) after switching to the recognition mode for enabling the object recognition to one or more physical object(s).

Step S21: local host 10 controls the image capture device 11 (namely the second image capture device) to capture a physical object (namely second physical object) for retrieving a detection image.

One of the exemplary embodiments, under the recognition mode, the local host 10 may detect whether the capture trigger condition is fulfilled, and control the image capture device 11 to shoot when the capture trigger condition satisfy.

One of the exemplary embodiments, under the recognition mode, the local host 10 control the image capture device 11 to continuedly capture the detection images and store the currently captured detection image when the capture trigger condition is fulfilled.

The above-mentioned capture trigger condition may comprise reception of the designated user operation (such as a button of enabling recognition mode) or detection of the designated status (such as sensing that the human enters the capture range of the image capture device 11 or the second physical object was moved), but this specific example is not intended to limit the scope of the present disclosed example.

Step S22: the local host 10 executes the object-recognizing process on the detection image according to the loaded object-recognizing model for determining whether the captured second physical object belongs to the identification information corresponding to any loaded object-recognizing model.

One of the exemplary embodiments, the local host 10 is configured to execute the object-recognizing process on the detection image according to a plurality of recognition rules of each object-recognizing model for determining whether the detection image comprises the image of the first physical object corresponding to this object-recognizing model. If the detection image comprises image of the corresponding first physical, the local host 10 determines that the captured second physical object belongs to the identification information corresponding to this object-recognizing model, such as the first physical object and the second physical object are the same commodity. Namely, the identification information used to express the first physical object is suitable to express the captured second physical object.

Step S23: the local host 10 may execute a default procedure according to the recognition result (namely the identification information) after retrieving the identification information of the captured second physical object.

One of the exemplary embodiments, taking the unmanned store for example, the local host 10 may retrieve the commodity information of the second physical object according to the identification information, and execute a procedure of adding to shopping cart or a procedure of automatic checkout according to the commodity information.

One of the exemplary embodiments, taking unmanned warehousing for example, the local host 10 may retrieve the goods information of the second physical object according to the identification information, and execute a procedure of warehousing in or a procedure of warehousing out.

Step S24: the local host 10 determines whether the recognition (such as determining whether the user turns off the function of object recognition, or shuts down the image capture device 11 or the local host 10) is terminated.

If the local host 10 determines that the recognition is terminated, the local host 10 switches out the recognition mode. Otherwise, the local host 10 performs the steps S21-S23 again for executing the objection recognition on another second physical object.

The present disclosed example can effectively use the generated object-recognizing model to implement the automatic recognition of physical object, and save the time and cost caused by recognition by the human manually.

Please be noted that the local host 10 and the image capture device 11 used to execute the training mode and the local host 10 and the image capture device 11 used to execute the recognition mode may be respectively the same or different devices, but this specific example is not intended to limit the scope of the present disclosed example.

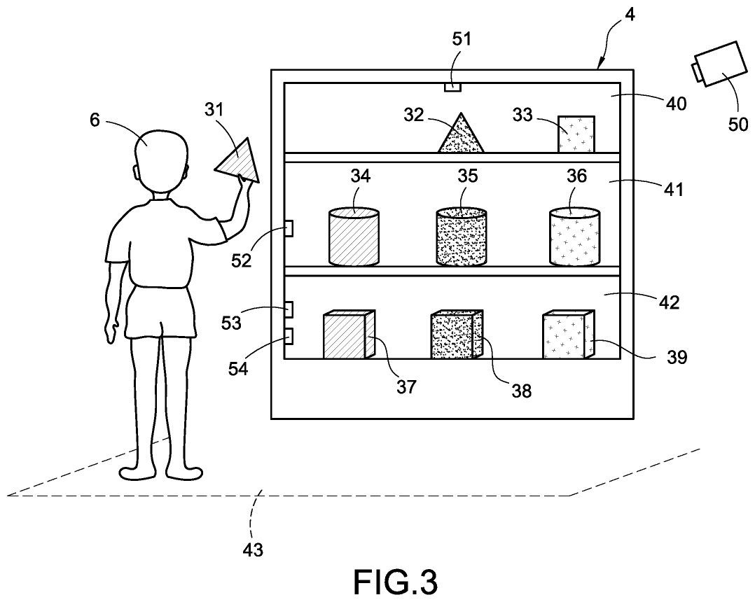

Please refer to FIG. 3, which is a schematic view of recognizing a physical object according to one of embodiments of the present disclosed example. FIG. 3 takes an unmanned store for example to explain one detailed implementation of the object-recognizing model generated by the present disclosed example. More specifically, a shelf 4 in the unmanned store may be divided into the zones 40-43. The second physical objects 31-33 are placed in zone 40, and the second image capture device 51 is installed in the zone 40. The second physical objects 34-36 are placed in zone 41, and the second image capture device 52 is installed in zone 41. The second physical objects 37-39 are placed in zone 41, and the second image capture devices 53 and 54 are installed in zone 42. The physical objects 31-39 respectively correspond to the different commodities.

The local host 10 may load the nine object-recognizing models respectively corresponding to the second physical objects 31-39 after switching to the recognition mode for enabling the recognition functions of the nine types of second physical objects.

After the human 6 enter the sensing zone 43, the local host 10 may retrieve the identity data of the human 6 (such as execution of face recognition by the second image capture device 50 or induction by the RFID reader of the RFID tag hold by the human 6). Then, when the human 6 takes any second physical object (for example, the human 6 takes the second physical object 31), the local host 10 may capture the detection image of the second physical image 31 taken by the human 6 by the second image capture device 50 or the second image capture device 51 in zone 40, and execute the object recognition on the detection image via the loaded object-recognizing model. Moreover, after successful recognition, the local host 10 may retrieve the identification information of the second physical object 31 (namely, the identification information corresponding to the object-recognizing model used to recognize successfully).

Then, the local host 10 may retrieve the commodity data corresponding to this identification information, and associate the commodity data with the identity data of the human 6 (such as adding the commodity data to the shopping cart list corresponding to the identity data of the human 6).

Thus, the object-recognizing model generated by the present disclosed example can effectively be applied to the commodity recognition of the unmanned store.

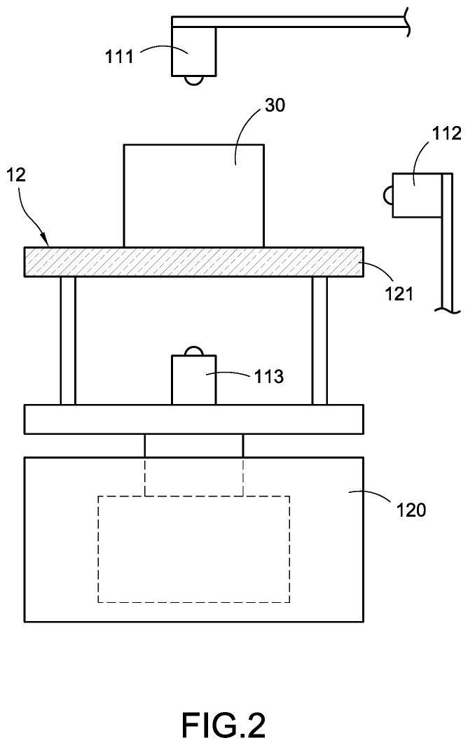

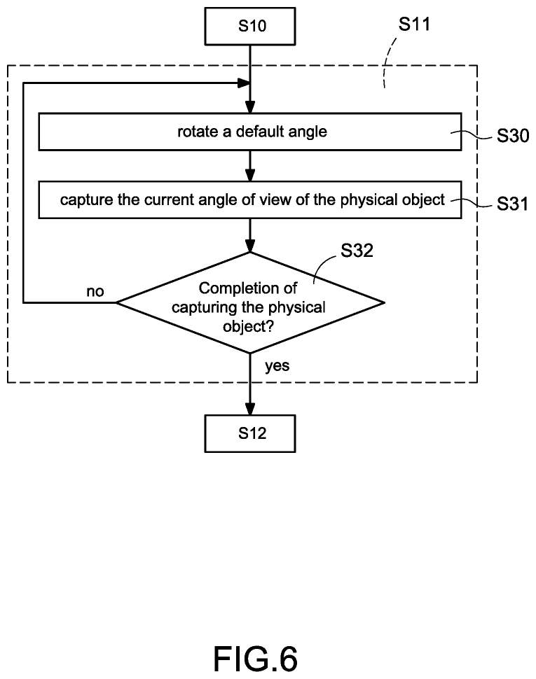

Please refer to FIG. 2 and FIG. 6 together. FIG. 2 is a schematic view of capturing a physical object according to one of embodiments of the present disclosed example. FIG. 6 is a flowchart of capturing physical object according to the third embodiment of the present disclosed example.

The system of building object-recognizing model of this embodiment comprises three fixedly arranged first image capture devices 111-113. The first image capture device 111 is used to capture the upper surface of the first physical object 30, the first image capture device 112 is used to capture the side surface of the first physical object 30, and the first image capture device 113 is used to capture the lower surface of the first physical object 30. The capture frame 12 comprises a carrier platform 121 with high light-transmission (such as light-transmissive acrylic plate), and the carrier platform 121 is arranged on the rotation device 120 (in this embodiment, the rotation device 120 is a rotatable base), so as to be rotated according to control.

Compare to the method of building object-recognizing model automatically of the embodiment shown in FIG. 4, the step S11 of the method of building object-recognizing model automatically of this embodiment comprises following steps.

Step S30: when the first physical object 30 is placed on the carrier platform 121 and the local host 10 switches to the training mode, the local host 10 controls the capture frame 12 to rotate for a default angle (such as 10 degrees) by the rotation device 120, and the first physical object 30 is rotated for the same default angle with the rotation device 120.

Step S31: the local host 10 controls the first image capture devices 111-113 to capture the different angles of views of the first physical object simultaneously for obtaining three sample images of the different angles of views of the first physical object.

Step S32: the local host 10 determines whether the capture procedure is finished, such as whether all of the angles of views of the first physical object 30 have been captured or the accumulated rotation angle of the rotation device 120 is not less than a default value (such as 360 degrees).

If the local host 10 determines that the capture procedure is finish, the local host 10 performs step S12. Otherwise, the local host 10 performs the steps S30-S31 repeatedly until all of the angles of views of the first physical object 30 have been captured.

For example, the local host 10 controls the capture frame 12 to rotate for the default angle again by the rotation device 120 for making the other different angles of the views of the first physical object 30 heading to the image capture devices 111-113, controls the first image capture devices 111-113 to capture the other different angles of the views of the first physical object 30 for obtaining the three sample images of the other different angles of the views of the first physical object 30, and so forth.

Thus, the present disclosed example can obtain the sample images of all of the angles of views of the first physical object 30.

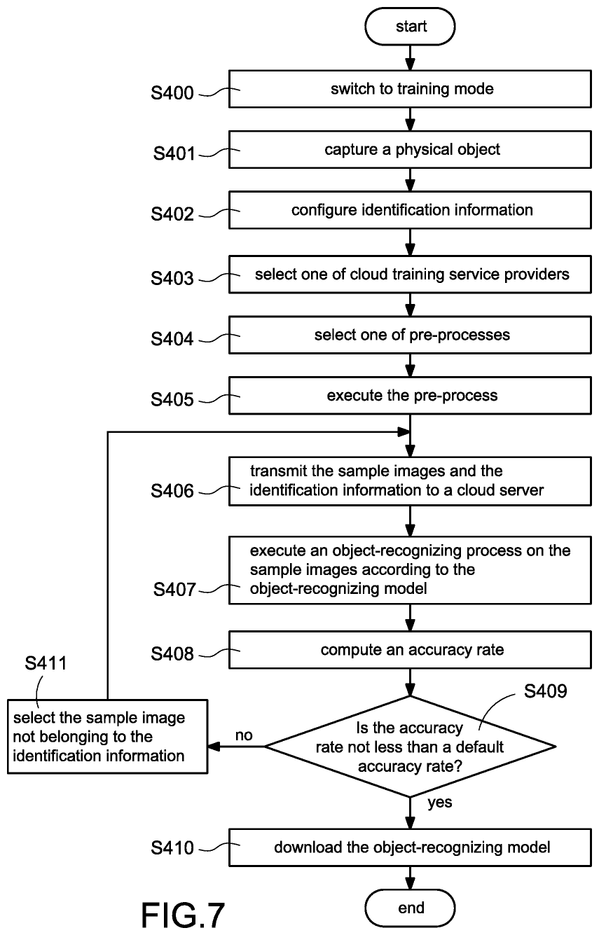

Please refer to FIG. 7, which is a flowchart of a method of building object-recognizing model automatically according to the fourth embodiment of the present disclosed example. Compare to the method of building object-recognizing model automatically shown in FIG. 4, the method of building object-recognizing model automatically of this embodiment further comprises the steps S404 and S405 for implementing a function of pre-process and the steps S407 and S408 for implementing a function of computing accuracy rate. The method of building object-recognizing model automatically of this embodiment comprises following steps.

Step S400: the local host 10 switches to the training mode.

Step S401: the local host 10 controls the image capture device 11 to capture the different angles of views of the physical object placed on the capture frame 12 for obtaining the sample images respectively corresponding to the different angles of views of the physical object.

Step S402: the local host 10 receives the identification information used to express the currently captured physical object by the human-machine interface.

Step S403: the local host 10 receives the provider-selecting operation by the human-machine interface, and selects one of a plurality of cloud training service providers according to the provider-selecting operation.

Step S404: the local host 10 selects one or more pre-process(es) according to the selected cloud training service provider.

More specifically, because the formats or image contents of the sample images being acceptable by each cloud training service providers are slightly different, the present disclosed example can provide a plurality of different pre-process programs according to the different limitations respectively required by the different cloud training service provides, and store the pre-process programs in the local host 10. the above-mentioned pre-process program can make the local host 10 execute the corresponding pre-process on the sample images after execution.

One of the exemplary embodiments, the pre-processes comprises a process of swapping background color and a process of marking object.

For example, if the selected cloud training service provider is Microsoft Azure Custom Vision Service, the local host may execute the process of swapping background color on the sample images.

In another example, if the selected cloud training service provider is Google Cloud AutoML Vision, the local host may execute the process of marking object on the sample images.

Step S405: the local host 10 executes the selected pre-process on the sample images.

Taking the process of swapping background color for example, the local host 10 may modify the background color of each sample image to make the background colors of the sample images be different with each other.

Taking the process of marking object for example, the local host 10 may automatically recognize the image of each physical object in each sample image, and execute a marking process on the recognized images (such as marking each image of physical object with a bounding box, or retaining each image of physical object and removing the other image).

Step S406: the local host 10 transmits the processed sample images and the identification information to the cloud server 21 of the selected cloud training service provider for making the cloud server 21 execute the learning training on the processed sample images and generate one object-recognizing model.

Step S407: after generation of the object-recognizing model, the local host 10 may control the cloud server 21 to use to execute the object-recognizing process on the uploaded sample images by the generated object-recognizing model for confirming whether the object-recognizing model can correctly determine each sample image belongs to the identification information (namely, the sample images match with the recognition rules of the object-recognizing model).

Step S408: the local host 10 may control the cloud server 21 to compute an accuracy rate of this object-recognizing model according to the result of object recognition of the sample images.

One of the exemplary embodiments, the local host 10 computes the accuracy rate according to the number of the sample images belonging to the identification information. Furthermore, the local host 10 may make the number of the sample images belonging to the identification information divide by a total number of the sample images for obtaining the above-mentioned accuracy rate.

Step S409: the local host 10 determines whether the computed accuracy rate is not less than the default accuracy rate (such as 60%).

If the accuracy rate is not less than the default accuracy rate, the local host 10 determines that this object-recognizing model meets requirements, the learning training is unnecessary to be executed again, and the local host 10 performs step S410. If the accuracy rate is less than the default accuracy rate, the local host 10 determines that the accuracy rate of this object-recognizing model is insufficient, the learning training is necessary to be executed again, and the local host 10 performs step S411.

Step S410: the local host 10 receives (downloads) this object-recognizing model from the cloud server 21 via Internet.

One of the exemplary embodiments, the local host 10 downloads a deep learning package of the object-recognizing model from the cloud server 21.

One of the exemplary embodiments, the above-mentioned deep learning package may be Caffe, TensorFlow, CoreML, CNTK and/or ONNX.

If the accuracy rate is less than the default accuracy rate, the local host 10 performs step S411: the local host 10 selecting the sample images not belonging to the identification information.

Then, the local host 10 performs the steps S406-S409 again to transmit the selected sample images not belonging to the identification information and the identification information to the cloud server 21 of the same cloud training service provider for making the cloud server 21 execute the learning training on the sample images not belonging to the identification information again and generate the retrained object-recognizing model.

The present disclosed example can effectively ensure that the obtained object-recognizing model with high accuracy rate via automatically computing the accuracy rate and repeatedly execute the learning training if the accuracy rate is insufficient, and improve a correct rate of following object recognition.

The above-mentioned embodiments are only preferred specific examples in the present disclosed example, and are not thence restrictive to the scope of claims of the present disclosed example. Therefore, those who apply equivalent changes incorporating contents from the present disclosed example are included in the scope of this application, as stated herein.

What is claimed is:

1. A method of building object-recognizing model automatically, comprising following steps:
a) capturing a plurality of different angles of views of appearance of a first physical object by an image capture device in a training mode for obtaining a plurality of sample images;
b) configuring identification information of the sample images, wherein the identification information is used to represent the first physical object;
c) selecting one of a plurality of cloud training service providers according to a provider-selecting operation;
d) transmitting the sample images and the identification information to a cloud server of the selected cloud training service provider for making the cloud server execute a learning training on the sample images; and
e) receiving an object-recognizing model corresponding to the identification information from the cloud server.

2. The method of building object-recognizing model automatically of claim 1, further comprising following steps:
f1) capturing a second physical object by a second image capture device under a recognition mode for retrieving a detection image; and
f2) executing an object-recognizing process on the detection image according to the object-recognizing model for determining whether the second physical object belongs to the identification information.

3. The method of building object-recognizing model automatically of claim 1, wherein the step a) comprises following steps:
a1) switching to the training mode;
a2) controlling a capture frame on which the first physical object is placed to rotate for a default angle;
a3) controlling each first image capture device arranged fixedly to capture the first physical object for obtaining at least one of the sample images; and
a4) performing the step a2) to the step a3) repeatedly until all of the angles of views of the first physical object are captured.

4. The method of building object-recognizing model automatically of claim 1, further comprising following steps after the step c) and before the step d):
g1) selecting at least one of pre-processes according to the selected cloud training service providers; and
g2) executing the selected pre-process on the sample images;
wherein, the step d) is performed to transmit the processed sample images and the identification information to the cloud server.

5. The method of building object-recognizing model automatically of claim 4, wherein the pre-processes comprise a process of swapping background color and a process of marking object.

6. The method of building object-recognizing model automatically of claim 4, wherein the cloud training service providers comprises Microsoft Azure Custom Vision Service and Google Cloud AutoML Vision.

7. The method of building object-recognizing model automatically of claim 1, further comprising following steps before the step e):
h1) executing an object-recognizing process respectively on the sample images according to the object-recognizing model for determining whether each sample image belongs to the identification information; and
h2) computing an accuracy rate according to the sample images belonging to the identification information.

8. The method of building object-recognizing model automatically of claim 7, further comprising step of i) when the accuracy rate is less than a default accuracy rate, transmitting the sample images not belonging to the identification information and the identification information to the cloud server for making the cloud server execute the learning training on the sample images not belonging to the identification information.

9. The method of building object-recognizing model automatically of claim 7, wherein the step e) is performed to download the object-recognizing model from the cloud server when the accuracy rate is not less than the default accuracy rate.

10. The method of building object-recognizing model automatically of claim 1, wherein the step e) is performed to download a deep learning package of the object-recognizing model from the cloud server, the deep learning package is Caffe, TensorFlow, CoreML, CNTK or ONNX.
